(19) United States
(12) Patent Application Publication
(10) Pub. No.: US 2013/0247470 A1
(43) Pub. Date: Sep. 26, 2013

(54) SEAL MECHANISM OF HIGH PRESSURE COFFEE MACHINE

(71) Applicants: Weijun Zhong, Zhangzhou (CN); Hongshuai Deng, Zhangzhou (CN)

(72) Inventors: Weijun Zhong, Zhangzhou (CN); Hongshuai Deng, Zhangzhou (CN)

(73) Assignee: TSANN KUEN (ZHANGZHOU) ENTERPRISE CO., LTD., Zhangzhou, Fujian (CN)

(21) Appl. No.: 13/990,561

(22) PCT Filed: Nov. 23, 2011
(86) PCT No.: PCT/CN2011/082662

§ 371 Date: May 30, 2013

(30) Foreign Application Priority Data
Nov. 30, 2010 (CN) 201020635733.X

(51) Int. Cl. A47J 31/44

(52) U.S. Cl. CPC A47J 31/4407
USPC 49/383

(57) ABSTRACT

A seal mechanism of a high pressure coffee machine has an upper cover, a rotary cover and a lower body. The back end of the upper cover, the back end of the rotary cover and the back of the lower body are pivotally connected. A coffee box with an upward opening is arranged on the lower body, and a sealing piece is arranged under the rotary cover; the hook mechanism is arranged between the upper cover and the lower body; the closing mechanism is arranged between the upper cover and the rotary cover, which comprises the handle, the closing piece and the opening and closing rod; the handle is connected to the upper cover. The closing piece and the handle form a connection. The opening and closing rod and the handle form a connection.

### FIELD OF THE INVENTION

The present invention relates to a seal mechanism of high pressure coffee machine.

### BACKGROUND OF THE INVENTION

The high pressure coffee machine at the prior art can be used for extracting and making coffee bag and coffee capsule, and its seal mechanism comprises the lower body and the upper cover, and the lower body and the upper cover are pivotally connected together. A coffee box with upward opening is arranged above the lower body, and a sealing piece is arranged below the upper cover, and the sealing piece and the coffee box opening are coupling with each other. And a hook mechanism is arranged between the lower body and the upper cover. Because only a hook mechanism is arranged between the upper cover and the lower body, the sealing force between the sealing piece and the coffee box is bear by the hook mechanism, the sealing performance is not good, and the sealing performance can be damaged by the shake during the high pressure extraction process.

### SUMMARY OF THE INVENTION

The object of the present invention is to offer a seal mechanism of high pressure coffee machine which overcomes the defect at the prior art.

The technical proposal solving the technical matter in the present invention is:

A seal mechanism of high pressure coffee machine, comprises an upper cover (100), a rotary cover (200) and a lower body (300), the back end of the upper cover (100), the back end of the rotary cover (200) and the back of the lower body (300) are pivotally connected together, a coffee box (310) with upward opening is arranged on the lower body (300), and a sealing piece (210) that can adaptively cover the opening of the coffee box (310) is arranged under the rotary cover (200);

The hook mechanism is arranged between the upper cover (100) and the lower body (300);

The closing mechanism is arranged between the upper cover (100) and the rotary cover (200), which comprises the handle (120), the closing piece (130) and the opening and closing rod (140); the handle (120) is moveably connected to the upper cover (100), the closing piece (130) and the handle (120) form an interlock connection relationship and are against above the rotary cover (200), and the opening and closing rod (140) and the handle (120) form a interlock connection relationship to adaptive to the hook mechanism.

In a preferred embodiment, the closing piece (130) is a cam, and the cam and the handle (120) form a synchronous coaxial rotation connection relationship, and the peripheral surface of the cam is against the rotary cover (200).

In a preferred embodiment, the opening and closing rod (140) and the handle (120) form a synchronous coaxial rotation connection relationship.

In a preferred embodiment, the hook mechanism comprises the hook (110) and the neck (320), the hook (110) is pivotally connected to the upper cover (100) and is adaptive to the opening and closing rod (140), and the neck (320) is arranged at the side of the lower body (300).

In a preferred embodiment, an opening and closing torsional spring (170) is arranged between the opening and closing rod (140) and the upper cover (100).

In a preferred embodiment, the necks (320) are arranged at the two sides of the lower body (300); the hooks (110) are pivotally connected to the two sides of the upper cover (100).

In a preferred embodiment, the handle (120) is pivotally connected to the upper cover (100), and the pivot of the handle (120) is on the first plane that is vertical to the sealing piece (210) and penetrates the centre of the circle of the sealing piece (210).

In a preferred embodiment, the front end of the upper cover (100) extends downward to form a fixing part (150), and the lower end of the fixing part (150) extends forward to form a locating part (160); the front end of the rotary cover (200) is arranged between the upper cover (100) and the locating part (160), and the thickness of the front end of the rotary cover (200) is small than the distance between the upper cover (100) and the locating part (160), and a pressure spring (220) is arranged between the rotary cover (200) and the locating part (160).

In a preferred embodiment, a flicking torsional spring (500) is arranged between the lower body (300) and the rotary cover (200).

Compared with the technical proposal at the prior, the benefits of the present invention are:

1 The hook mechanism and the closing mechanism are arranged among the lower body, the rotary cover and the upper cover, so that the sealing force between the coffee box and the sealing piece is large, and the sealing performance is good, the operation is labor-saving, convenient and simple;

2 The pivot of the handle is on the first plane that is vertical to the sealing piece and penetrates the centre of the circle of the sealing piece, so that the handle is vertical to the rotary cover after the handle is pressed down, namely is provide with the same direction as the pressure generated from the coffee bag or the café capsule during the extraction process, and then the rotary cover is clamped, which will not flick during the extraction process, guaranteeing the sealing effects.

3 The cam and the handle form a synchronous coaxial rotation connection relationship, the cam is coupling with the rotary cover, so that the structure is simple;

4 The opening and closing rod (140) and the handle (120) form a synchronous coaxial rotation connection relationship, the structure is simple.

### BRIEF DESCRIPTION OF THE DRAWINGS

With the following description of the drawings and specific embodiments, the invention shall be further described in details.

FIG. 1 shows the solid exploded view of the seal mechanism of high pressure coffee machine;

FIG. 2 shows the front exploded view of the seal mechanism of high pressure coffee machine;

FIG. 3 shows the plan view of the seal mechanism of high pressure coffee machine;

FIG. 4 shows the front view of the seal mechanism of high pressure coffee machine, the seal mechanism is opened at this moment;

FIG. 5 shows the front view of the seal mechanism of high pressure coffee machine, the hook is clamped to the neck;

FIG. 6 shows the sectional view of FIG. 3 B-B, the close state is present;

FIG. 7 shows the sectional view of FIG. 3 A-A, the close state is present;

FIG. 8 shows the sectional view of FIG. 3 C-C, the close state is present;

### DESCRIPTION OF THE PREFERRED EMBODIMENTS

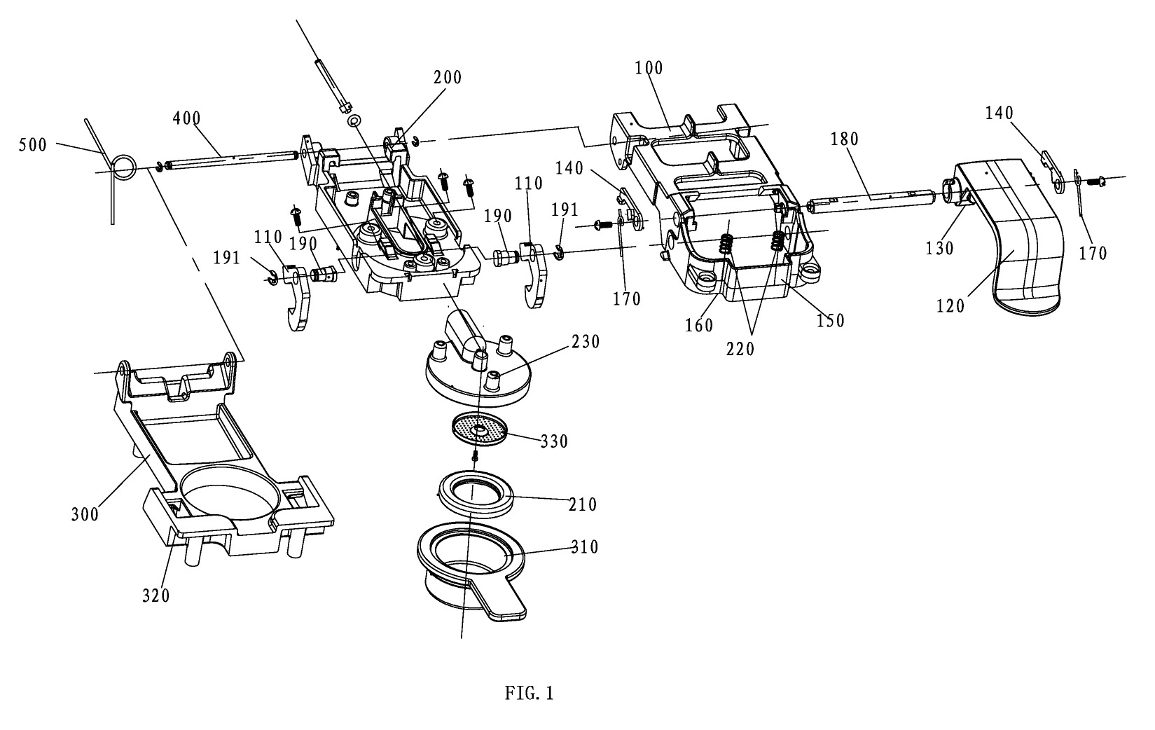

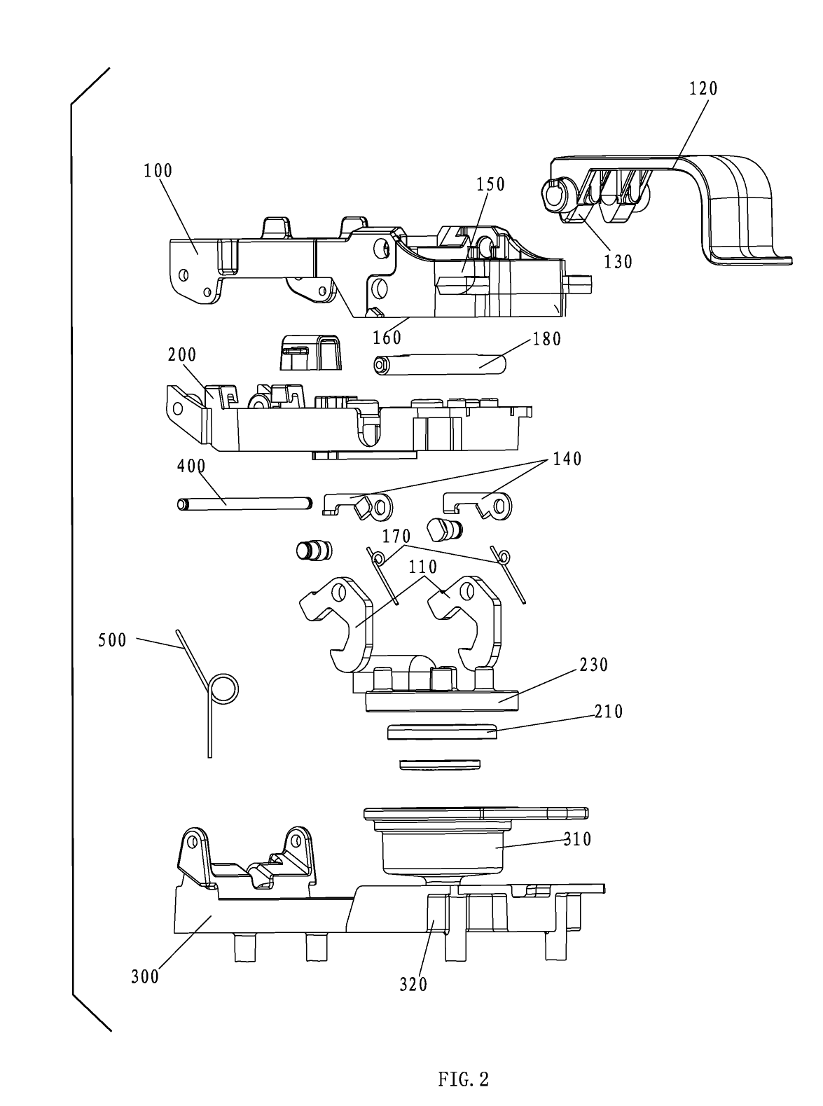

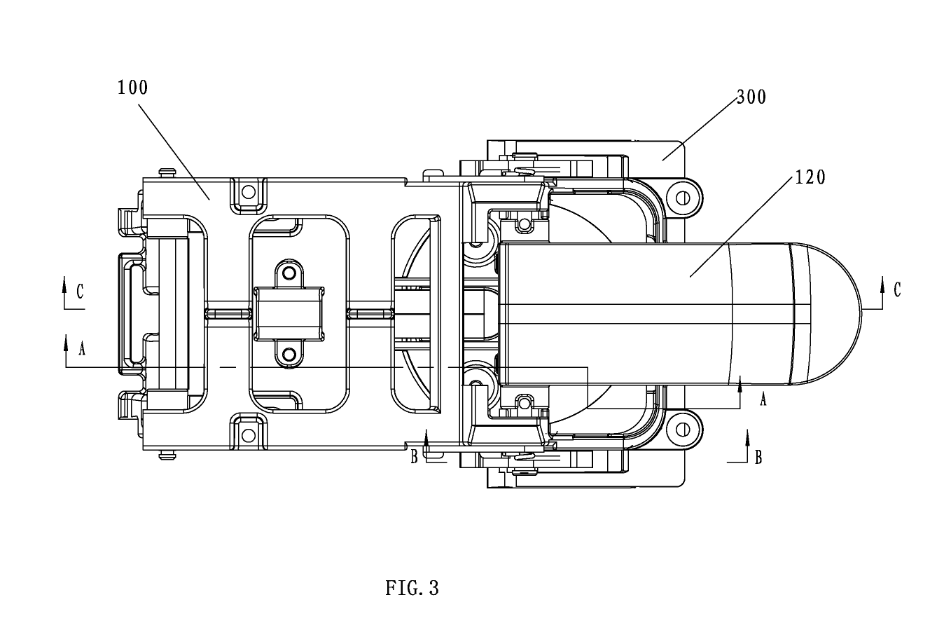

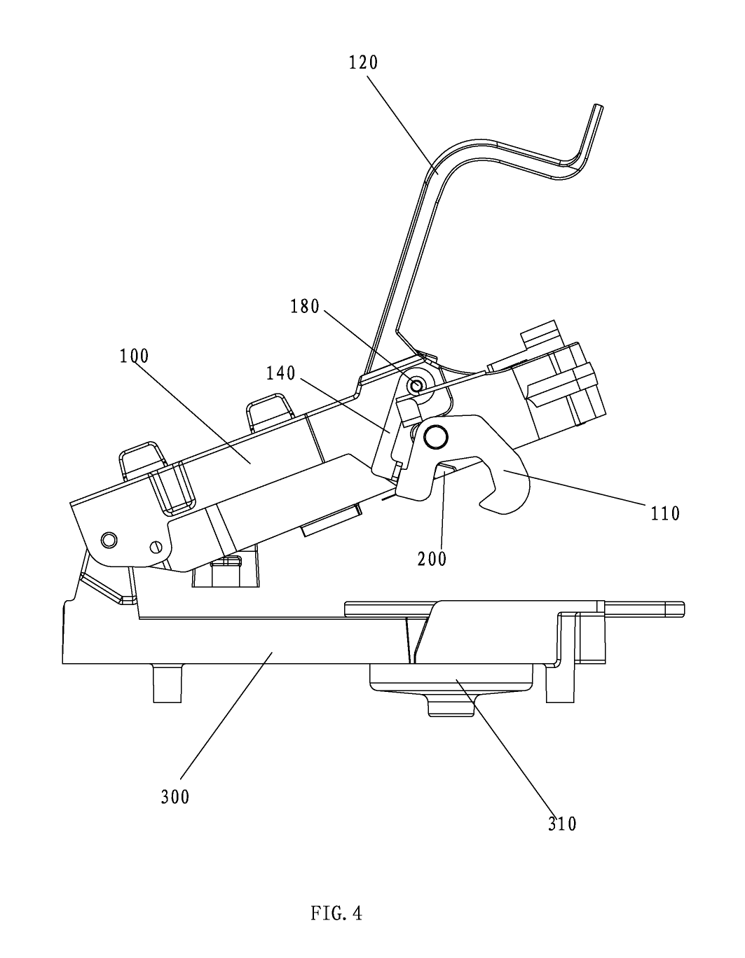

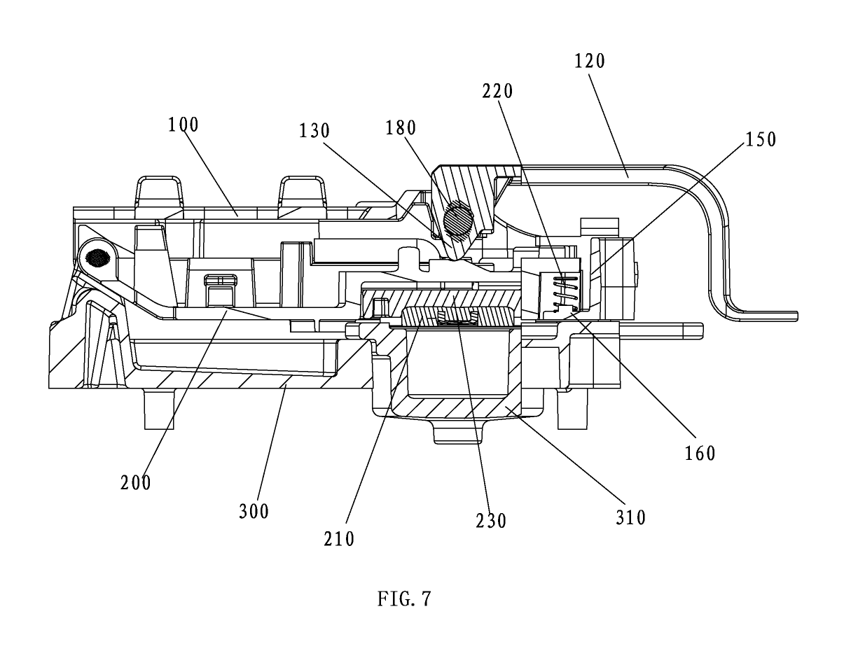

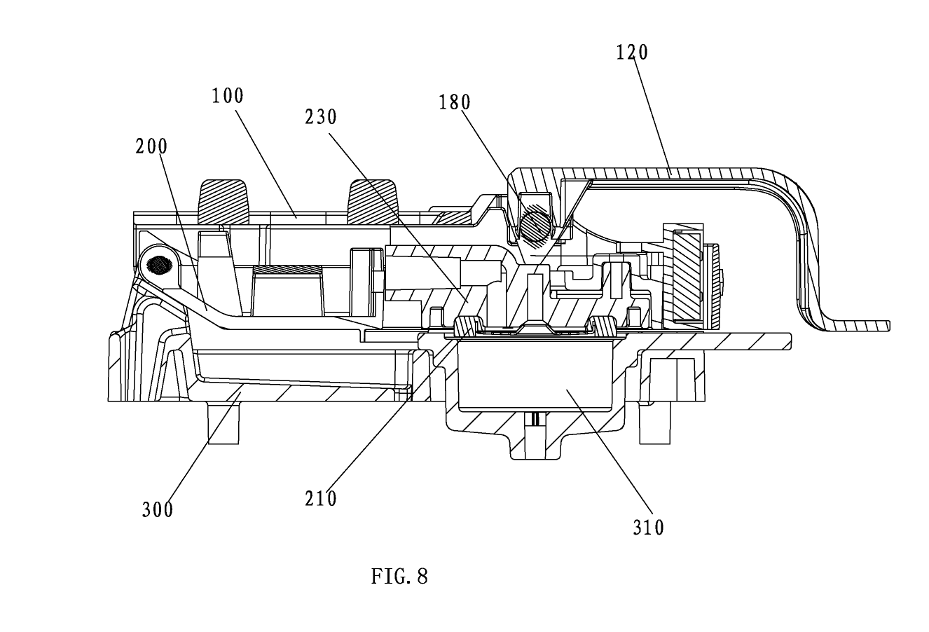

According to FIG. 1 to FIG. 8, a seal mechanism of high pressure coffee machine, it comprises an upper cover 100, a rotary cover 200 and a lower body 300, the back end of the upper cover 100, the back end of the rotary cover 200 and the back of the lower body 300 are pivotally connected together through the back pivot 400, and a flicking torsional spring 500 is arranged between the lower body 300 and the rotary cover 200.

A coffee box 310 with upward opening is opened at the front middle part of the lower body 300, and an extraction strainer 330 is arranged in the coffee box 310.

In the present embodiment, a groove is concavely arranged on the bottom surface of the front middle part of the rotary cover 200, and a fixator 230 is inlaid at the groove, and a sealing piece 210 that can adaptively cover the opening of the coffee box 310 is arranged on the bottom surface of the fixator 230.

The front end of the upper cover 100 extends downward to form a fixing part 150, and the lower end of the fixing part 150 extends forward to form a locating part 160; the front end of the rotary cover 200 is arranged between the upper cover 100 and the locating part 160, and the thickness of the front end of the rotary cover 200 is small than the distance between the upper cover 100 and the locating part 160, so that the front end of the rotary cover 200 can be rotated relative to the upper cover 100, and a pressure spring 220 is arranged between the rotary cover 200 and the locating part 160.

Two hook mechanisms are arranged between the upper cover 100 and the lower body 300. The hook mechanism comprises a hook 110 and a neck 320, the two necks 320 are arranged to the two sides of the lower body 300, and the two hooks 110 are pivotally connected to the two sides of the upper cover 100 through the hook shaft 190 and are located through the clamping piece 191.

A closing mechanism is arranged between the upper cover 100 and the rotary cover 200, which comprises a handle 120, a closing piece 130 and two opening and closing rods 140.

The handle 120 is pivotally connected on the front end of the upper cover 100. The closing piece 130 is a cam, and the cam and the handle 120 form a synchronous coaxial rotation connection relationship, and the peripheral surface of the cam is against the rotary cover 200, and correspondingly located above the fixator 230. As a consequence, when the handle 120 rotates relatively to the upper cover 100, it can drive the rotation of the cam, and can be against the rotary cover 200 to rotate downward, so that the sealing piece 210 is closing on the coffee box 10, or, the rotary cover 200 can be against by the pressure spring 200 to rotate upward, so that the closing between the sealing piece 210 and the coffee box 310 can be loosen. Preferably, the pivot of the handle 120 is on the first plane that is vertical to the sealing piece 210 and penetrates the centre of the circle of the sealing piece 210.

The two opening and closing rods 140 are connected to the two sides of the handle 120 respectively, and the opening and closing rod 140 and the handle 120 form a synchronous coaxial rotation connection relationship. The two opening and closing rods 140 are coupling with the two hooks 110 respectively, namely can be against the hooks 110 respectively to make the hooks reversal, and then the hook structure between the hook 110 and the neck 320 is loosen, and namely the opening and closing rod 140 and the handle 120 form a interlock connection relationship to adaptive to the hook mechanism. Preferably, an opening and closing torsional spring 170 is arranged between the opening and closing rod 140 and the upper cover 100.

In the present embodiment, the cam is fixedly connected to the handle, and the handle is fixedly connected to the handle shaft 180 and is pivotally connected to the upper cover through the handle shaft 180, and the opening and closing rod can be rotationally sleeved to the handle shaft 180 coaxially and synchronously.

For the examiner to better understand the present embodiment, the closing procedure of the seal mechanism is described below:

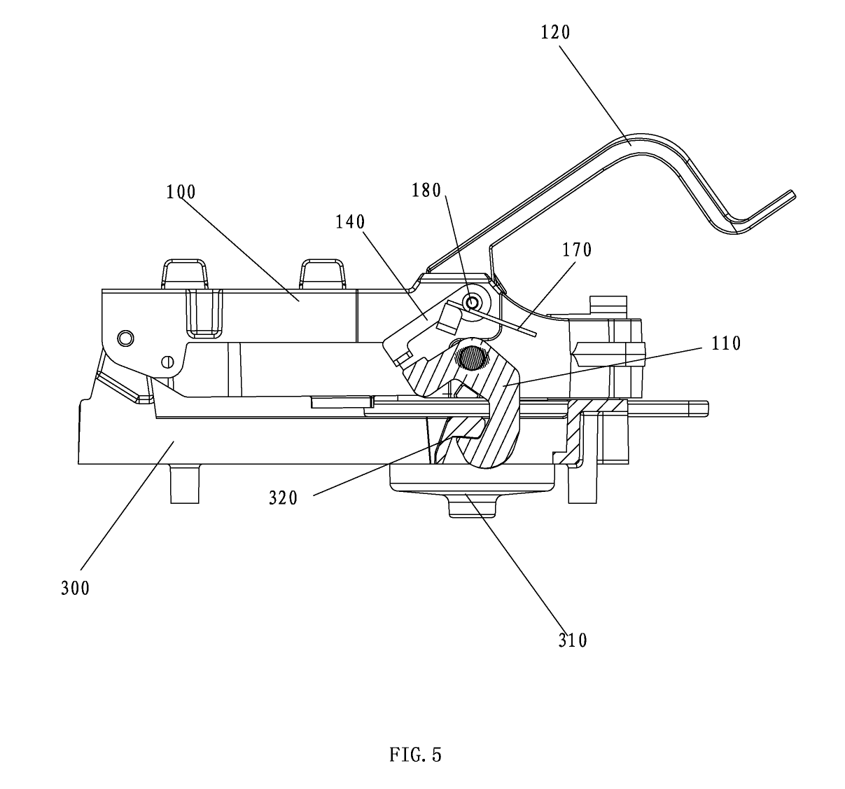

1 The downward pressure is exerted to the upper cover 100, and the elastic force of the flicking torsional spring 500 is overcome, and the upper cover 100 is rotated downward, and then the hook 110 is fixedly connected on the neck 320, the sealing piece 210 is located above the coffee box 310 at this moment, but the sealing piece 210 does not contacts the coffee box 310, so the tight handfeel from the compression is not generated, according to FIG. 5;

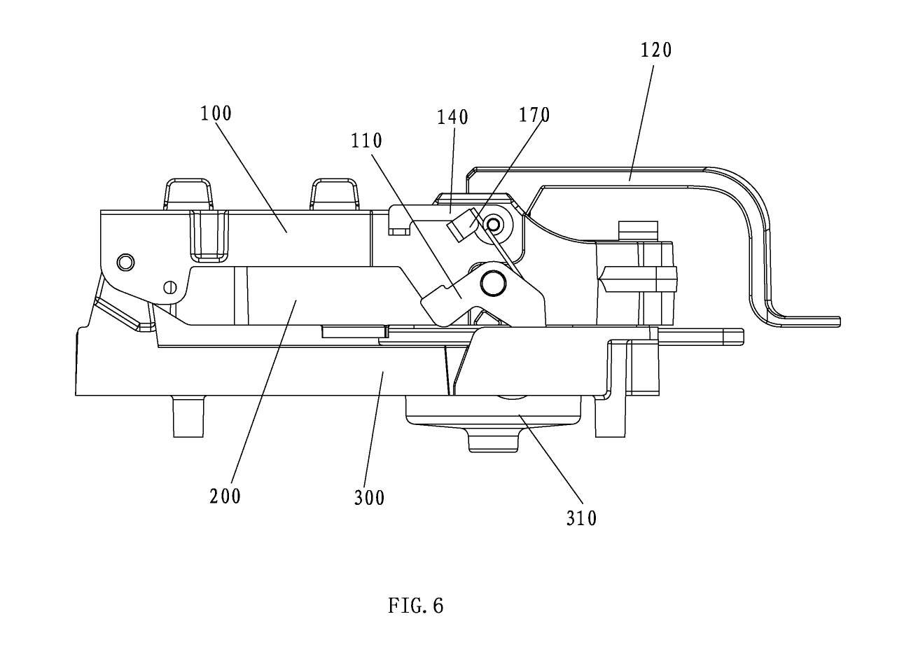

2 The handle 120 is pressed down, and the rotary cover 200 is pressed down by the cam 130, and the elastic force of the pressure spring 220 is overcome, and the rotary cover 200 is rotated down ward, so that the complete seal of the sealing piece and the coffee box is achieved, according to FIGS. 6, 7 and 8.

For the examiner to better understand the present embodiment, the opening procedure of the seal mechanism is described below:

1 The handle 120 is pulled up when opening, and the cam of the handle 120 will first release the rotary cover, and the compression of the sealing piece is released under the action of the pressure spring, and then the frictional force to the hooks and the lower body from the compression is decreased;

2 Then the handle 120 is pulled up again, the opening and closing rod fixedly connected to the two sides of the handle 120 will push the hooks down, so that the hooks quit from the lower body, then the opening action is achieved.

The invention has been described with reference to the preferred embodiments mentioned above; therefore it cannot limit the reference implementation of the invention. It is obvious to a person skilled in the art that structural modification and changes can be carried out without leaving the scope of the claims hereinafter and the description above.

### INDUSTRIAL APPLICABILITY

The seal mechanism of high pressure coffee machine in the present embodiment, a hook mechanism and a closing mechanism are arranged among the lower body, the rotary cover and the upper cover, so that the sealing force between the coffee box and the sealing piece is large, the sealing performance is good, the operation is labor-saving, convenient and simple, so the present invention is provided with good industrial applicability.

What is claimed is:

1. A seal mechanism of high pressure coffee machine, wherein, comprises an upper cover a rotary cover and a lower body the back end of the upper cover the back end of the rotary cover and the back of the lower body are pivotally connected together, a coffee box with upward opening is arranged on the lower body and a sealing piece that can adaptively cover the opening of the coffee box is arranged under the rotary cover;
The hook mechanism is arranged between the upper cover and the lower body;
The closing mechanism is arranged between the upper cover and the rotary cover which comprises the handle the closing piece and the opening and closing rod; the handle is moveably connected to the upper cover the closing piece and the handle form an interlock connection relationship and are against above the rotary cover and the opening and closing rod and the handle form a interlock connection relationship to adaptive to the hook mechanism.

2. A seal mechanism of high pressure coffee machine according to claim 1, wherein, the closing piece is a cam, and the cam and the handle form a synchronous coaxial rotation connection relationship, and the peripheral surface of the cam is against the rotary cover.

3. A seal mechanism of high pressure coffee machine according to claim 1, wherein, the opening and closing rod and the handle form a synchronous coaxial rotation connection relationship.

4. A seal mechanism of high pressure coffee machine according to claim 1, wherein, the hook mechanism comprises the hook and the neck the hook is pivotally connected to the upper cover and is adaptive to the opening and closing rod and the neck is arranged at the side of the lower body.

5. A seal mechanism of high pressure coffee machine according to claim 3, wherein, an opening and closing torsional spring is arranged between the opening and closing rod and the upper cover.

6. A seal mechanism of high pressure coffee machine according to claim 4, wherein, the necks are arranged at the two sides of the lower body; the hooks are pivotally connected to the two sides of the upper cover.

7. A seal mechanism of high pressure coffee machine according to claims 1, wherein, the handle is pivotally connected to the upper cover and the pivot of the handle is on the first plane that is vertical to the sealing piece and penetrates the centre of the circle of the sealing piece.

8. A seal mechanism of high pressure coffee machine according to claims 1, wherein, the front end of the upper cover extends downward to form a fixing part and the lower end of the fixing part extends forward to form a locating part; the front end of the rotary cover is arranged between the upper cover and the locating part and the thickness of the front end of the rotary cover is small than the distance between the upper cover and the locating part and a pressure spring is arranged between the rotary cover and the locating part.

9. A seal mechanism of high pressure coffee machine according to claim 1, wherein, a flicking torsional spring is arranged between the lower body and the rotary cover.

10. A seal mechanism of high pressure coffee machine according to claim 2, wherein, the handle is pivotally connected to the upper cover and the pivot of the handle is on the first plane that is vertical to the sealing piece and penetrates the centre of the circle of the sealing piece.

11. A seal mechanism of high pressure coffee machine according to claim 2, wherein, the front end of the upper cover extends downward to form a fixing part and the lower end of the fixing part extends forward to form a locating part; the front end of the rotary cover is arranged between the upper cover and the locating part and the thickness of the front end of the rotary cover is small than the distance between the upper cover and the locating part and a pressure spring is arranged between the rotary cover and the locating part.

12. A seal mechanism of high pressure coffee machine according to claim 3, wherein, the front end of the upper cover extends downward to form a fixing part and the lower end of the fixing part extends forward to form a locating part; the front end of the rotary cover is arranged between the upper cover and the locating part and the thickness of the front end of the rotary cover is small than the distance between the upper cover and the locating part and a pressure spring is arranged between the rotary cover and the locating part.

13. A seal mechanism of high pressure coffee machine according to claim 4, wherein, the front end of the upper cover extends downward to form a fixing part and the lower end of the fixing part extends forward to form a locating part; the front end of the rotary cover is arranged between the upper cover and the locating part and the thickness of the front end of the rotary cover is small than the distance between the upper cover and the locating part and a pressure spring is arranged between the rotary cover and the locating part.

14. A seal mechanism of high pressure coffee machine according to claim 5, wherein, the front end of the upper cover extends downward to form a fixing part and the lower end of the fixing part extends forward to form a locating part; the front end of the rotary cover is arranged between the upper cover and the locating part and the thickness of the front end of the rotary cover is small than the distance between the upper cover and the locating part and a pressure spring is arranged between the rotary cover and the locating part.

15. A seal mechanism of high pressure coffee machine according to claim 6, wherein, the front end of the upper cover extends downward to form a fixing part and the lower end of the fixing part extends forward to form a locating part; the front end of the rotary cover is arranged between the upper cover and the locating part and the thickness of the front end of the rotary cover is small than the distance between the upper cover and the locating part and a pressure spring is arranged between the rotary cover and the locating part.

16. A seal mechanism of high pressure coffee machine according to claim 2, wherein, a flicking torsional spring is arranged between the lower body and the rotary cover.

17. A seal mechanism of high pressure coffee machine according to claim 3, wherein, a flicking torsional spring is arranged between the lower body and the rotary cover.

18. A seal mechanism of high pressure coffee machine according to claim 4, wherein, a flicking torsional spring is arranged between the lower body and the rotary cover.

19. A seal mechanism of high pressure coffee machine according to claim 5, wherein, a flicking torsional spring is arranged between the lower body and the rotary cover.

20. A seal mechanism of high pressure coffee machine according to claim 6, wherein, a flicking torsional spring is arranged between the lower body and the rotary cover.
